(19) United States
(12) Patent Application Publication
(10) Pub. No.: US 2009/0171021 A1
(43) Pub. Date: Jul. 2, 2009

(54) Thermosetting resin composition, sealant for optical device, and cured product

(76) Inventor: Atsushi Sato, Yamaguchi (JP)

Correspondence Address: BIRCH STEWART KOLASCH & BIRCH, PO BOX 747, FALLS CHURCH, VA, 22040-0747, US

(21) Appl. No.: 11/630,691

(22) PCT Filed: Jul. 15, 2005
(86) PCT No.: PCT/JP2005/013168

§ 371 Date: Dec. 27, 2006

(30) Foreign Application Priority Data
Jul. 23, 2004 (JP) 2004-216383

(51) Int. Cl. C08L 63/00

(52) U.S. Cl. 525/55

(57) ABSTRACT

There is provided a thermosetting resin composition including a radical (co)polymer (A), at least one of polybasic acid anhydrides and polybasic acids (B); and an accelerator (C) as essential components, in which the radical (co)polymer (A) is a product of (co)polymerization of an ethylenically unsaturated monomer (a), optionally with an ethylenically unsaturated monomer (b) copolymerizable with the ethylenically unsaturated monomer (a), using a non-nitrile azo compound as a polymerization initiator, and the ethylenically unsaturated monomer (a) has one or more cycloaliphatic epoxy groups per molecule. There are also provided a sealant for optical devices, and a cured product. The thermosetting resin composition yields a cured product having high optical transparency and glass transition temperature Tg and showing satisfactory light stability and anti-cracking properties. It also yields a sealant for optical devices, which shows high optical transparency and glass transition temperature Tg and has satisfactory light stability and anti-cracking properties.

### TECHNICAL FIELD

The present invention relates to thermosetting resin compositions which yield cured products (articles) being highly optically transparent, having a high glass transition temperature (Tg) and satisfactory light stability, and being excellent in anti-cracking properties. It also relates to sealants for optical devices which mainly include the resin compositions, and to the resulting cured products.

### BACKGROUND ART

Optical devices include light-emitting. diodes, photosensors, and light-emitting devices and photoreceivers for optical communications. Resins used for sealing these devices and parts thereof should be optically transparent. They should have a high light transmittance and be satisfactory in properties such as thermal stability and water resistance. Among them, resins for use in blue- and white-emitting diodes should be avoided from decrease in luminance (intensity) due to deterioration with time caused by ultraviolet rays, because such blue- and white-emitting diodes emit rays having short wavelengths in the near-ultraviolet region.

To meet these requirements, aromatic epoxy resins and (3,4-epoxycyclohexyl)methyl 3′,4′-epoxycyclohexanecarboxylate are generally used among epoxy resins, and alicyclic acid anhydrides yielding good optical transparency are generally used as curing agents. The aromatic epoxy resins include, for example, bisphenol-A epoxy resins (bisphenol-A type epoxy resins) and cresol novolac epoxy resins (cresol novolac type epoxy resins). The alicyclic acid anhydrides include, for example, methylhexahydrophthalic anhydride, hexahydrophthalic anhydride, methyltetrahydrophthalic anhydride, and tetrahydrophthalic anhydride.

When aromatic epoxy resins such as bisphenol-A epoxy resins and novolac epoxy resins are thermally cured using the acid anhydrides, the resulting cured products have high glass transition temperatures Tg and good anti-cracking properties. They, however, deteriorate by the action of ultraviolet rays and undergo yellowing and thereby induce decreased luminances (intensities) of optical devices.

When cycloaliphatic epoxy compounds typified by (3,4-epoxycyclohexyl)methyl 3′,4′-epoxycyclohexanecarboxylate are thermally cured using the acid anhydrides, the resulting cured products are highly optically transparent, are excellently stable against light, have high glass transition temperatures Tg and are thereby satisfactory in properties. The cured products, however, are hard and fragile and thereby have poor anti-cracking properties. Flexible resins are generally incorporated into such epoxy resins to improve this. The incorporation, however, adversely affects the glass transition temperature Tg and light stability which are features of the cured products.

A nuclear hydrogenated product of bisphenol-A diglycidyl ether has been proposed as an epoxy resin (Japanese Unexamined Patent Application Publication (JP-A) No. 2003-026763). A cured product derived from this epoxy resin is highly optically transparent, is satisfactorily stable against light, and has good anti-cracking properties. The cured product, however, has a low glass transition temperature Tg of 120° C. to 130° C. and is still insufficient to provide highly reliable products as sealants for blue- and white-emitting diodes.

Nitrile azo compounds typified by azobisisobutyronitrile are generally used as polymerization initiators in the production of radical (co)polymers ((co)polymers obtained by radical (co)polymerization). In contrast, a photocurable resin composition using a non-nitrile azo compound has been proposed (Japanese Unexamined Patent Application Publication (JP-A) No. 2001-106765). This photocurable resin composition is a reaction product of an isocyanate compound containing a radical-polymerizable group with a radical (co)polymer having a hydroxyl group and an acidic functional group, in which the radical (co)polymer is prepared using a non-nitrile azo compound as a polymerization initiator. This publication, however, does not describe the use of a non-nitrile azo compound in the preparation of a radical (co)polymer having a cycloaliphatic epoxy group in its side chain. It also fails to refer to the preparation of a thermosetting resin composition by using the resulting radical (co)polymer having a cycloaliphatic epoxy group in combination with a polybasic acid anhydride and/or a polybasic acid.

Patent Document 1: Japanese Unexamined Patent Application Publication (JP-A) No. 2003-026763

Patent Document 2: Japanese Unexamined Patent Application Publication (JP-A) No. 2001-106765

### DISCLOSURE OF INVENTION

### Problems to be Solved by the Invention

Accordingly, an object of the present invention is to provide a thermosetting resin composition yielding a cured product which is highly optically transparent, has a high glass transition temperature Tg, is satisfactorily stable against light, and is satisfactory in anti-cracking properties. Another object of the present invention is to provide a cured product of the thermosetting resin composition. Yet another object of the present invention is to provide a sealant for optical devices yielding a sealed product which is highly optically transparent, has a high glass transition temperature Tg, is satisfactorily stable against light, and is satisfactory in anti-cracking properties.

### Means for Solving the Problems

After intensive investigations to achieve the objects, the present inventors have found that the objects can be achieved by a thermosetting resin composition containing a (co)polymer as a product of polymerization using a specific polymerization initiator. The present invention has been accomplished based on these findings.

Specifically, the present invention provides, according to a first embodiment, a thermosetting resin composition including a radical (co)polymer (A); at least one component (B) selected from polybasic acid anhydrides and polybasic acids; and an accelerator (C) as essential components, in which the radical (co)polymer (A) is a product of (co)polymerization of an ethylenically unsaturated monomer (a), optionally with an ethylenically unsaturated monomer (b), using a non-nitrile azo compound as a polymerization initiator, the ethylenically unsaturated monomer (a) has one or more cycloaliphatic epoxy groups per molecule, and the ethylenically unsaturated monomer (b) is copolymerizable with the monomer (a).

In the thermosetting resin composition according to the first embodiment, the ethylenically unsaturated monomers (a) and (b) are preferably free from carboxyl group and hydroxyl group (second embodiment). In the thermosetting resin composition according to the first or second embodiment, the accelerator (C) may be an accelerator other than amines and imidazoles (third embodiment). According to a fourth embodiment of the present invention, there is provided a sealant for optical devices, mainly including the thermosetting resin composition according to any one of the first, second, and third embodiments. According to a fifth embodiment of the present invention, there is provided a cured product derived from the thermosetting resin composition according to any one of the first, second, and third embodiments.

### Advantages

Thermosetting resin compositions according to the present invention yield cured products which are highly optically transparent, have high glass transition temperatures Tg, are satisfactory stable against light, and are excellent in anti-cracking properties.

### BEST MODE FOR CARRYING OUT THE INVENTION

The present invention will be illustrated in detail below.

Ethylenically unsaturated monomers (a) having one or more cycloaliphatic epoxy groups per molecule for use in the present invention are preferably those which do not contain carboxyl group and hydroxyl group. Preferred examples thereof are compounds represented by following General Formulae (1) and (2):

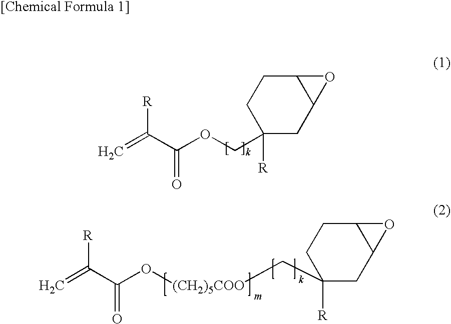

wherein “R”s may be the same as or different from each other and each represent hydrogen atom or methyl group; “k” represents an integer of 0 to 10; and “m” represents an integer of 0 to 10.

Specific examples of the compounds represented by General Formulae (1) and (2) include (3,4-epoxycyclohexyl) methyl(meth)acrylates and lactone-modified (3,4-epoxycyclohexyl) methyl(meth)acrylates. Among them, (3,4-epoxycyclohexyl) methyl(meth)acrylates are preferred, of which (3,4-epoxycyclohexyl)methyl methacrylate is particularly preferred. An unsaturated monomer (a) having carboxyl group and/or hydroxyl group is not preferably used. This is because the radical (co)polymer (A) may become unstable in storage under some storage conditions. In addition, if one having carboxyl group and/or hydroxyl group is used as the unsaturated monomer (a), cured products obtained as a result of thermal setting of the composition according to any one of the first, second, and third embodiments may have high water absorptivity and high hygroscopicity, and this may cause deterioration in performance as a sealant for optical devices.

The ethylenically unsaturated monomer (a) having one or more cycloaliphatic epoxy groups can also be the following compound described in Japanese Patent No. 2873482:

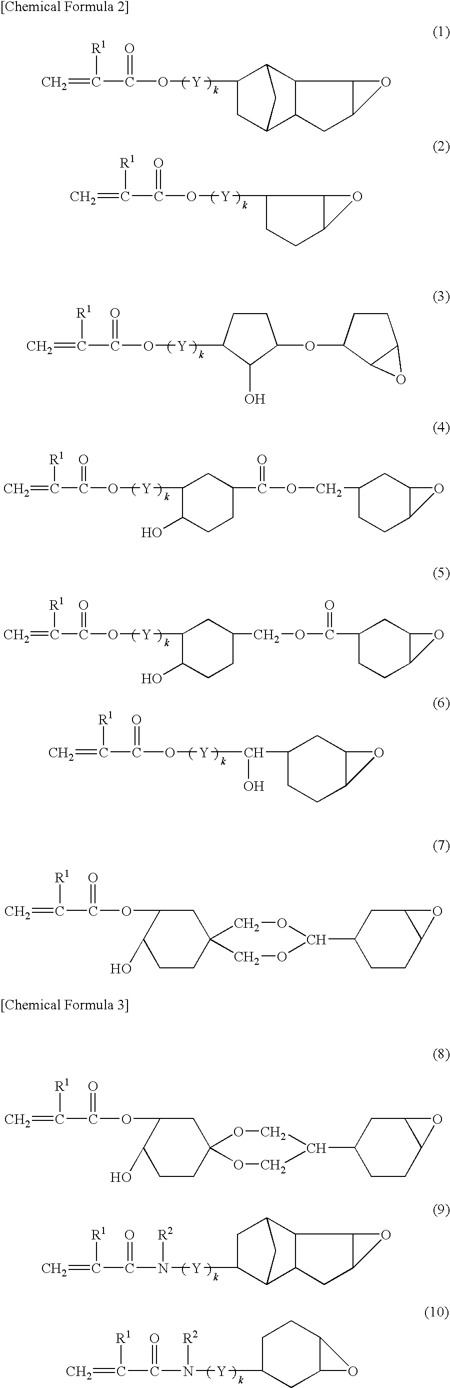

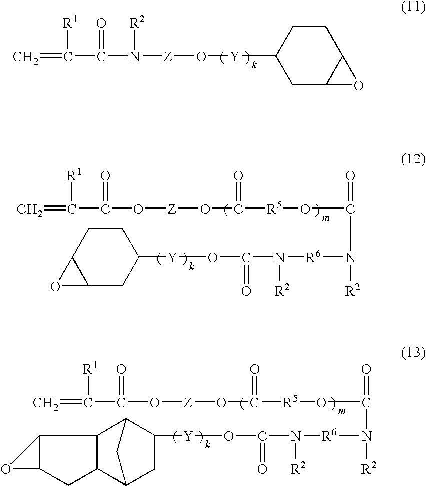

wherein R¹ and R² may be the same as or different from each other and each represent hydrogen atom or methyl group; Y and Z may be the same as or different from each other and each represent a divalent group represented by —[R³—C(═O)—O—]ₙ—R⁴—, wherein R³ represents a divalent aliphatic saturated hydrocarbon group having one to ten carbon atoms, R⁴ represents a divalent aliphatic saturated hydrocarbon group having one to six carbon atoms, and “n” represents an integer of 0 to 10; R⁵ and R⁶ may be the same as or different from each other and each represent a divalent aliphatic saturated hydrocarbon group having one to ten carbon atoms; “k” represents 0 or 1; and “m” represents an integer of 0 to 10.

Each of these ethylenically unsaturated monomers (a) having an epoxy group can be used alone or in combination in a monomer composition for use in the (co)polymerization of the monomer (a), optionally with the monomer (b).

Ethylenically unsaturated monomers (b) copolymerizable with the ethylenically unsaturated monomer (a) having one or more cycloaliphatic epoxy groups per molecule may be used in the present invention. Examples thereof are unsaturated monomers including acrylic or methacrylic esters of alkyl or cycloalkyl having one to twenty-four carbon atoms, such as methyl acrylate, methyl methacrylate, ethyl acrylate, ethyl methacrylate, n-, i-, or t-butyl acrylate, n-, i-, or t-butyl methacrylate, hexyl acrylate, hexyl methacrylate, octyl acrylate, octyl methacrylate, lauryl acrylate, lauryl methacrylate, stearyl acrylate, stearyl methacrylate, cyclohexyl acrylate, and cyclohexyl methacrylate; aromatic unsaturated monomers such as styrene, vinyltoluene, and alpha-methylstyrene; acrylamides and methacrylamides such as acrylamide, methacrylamide, N-methylacrylamide, and N-ethylmethacrylamide; and other unsaturated monomers such as vinyl propionate and vinyl acetate. Among them, n-butyl acrylate and n-butyl methacrylate are preferred. One having carboxyl group and/or hydroxyl group is not desirable as the unsaturated monomer (b). This is because the radical (co)polymer (A) may become unstable during storage under some storage conditions. In addition, if one having carboxyl group and/or hydroxyl group is used as the unsaturated monomer (b), cured products according to the fifth embodiment of the present invention obtained as a result of thermal setting of the composition according to any one of the first, second, and third embodiments may have high water absorptivity and high hygroscopicity, and this may cause deterioration in performance.

Each of these ethylenically unsaturated monomers (b) can be optionally used alone or in combination in the (co)polymerization of the monomer (a), optionally with the monomer (b). In addition, one or more ethylenically unsaturated monomers having glycidyl group, such as glycidyl methacrylate, can be used, within ranges not adversely affecting advantages of the present invention.

A composition for use in the (co)polymerization preferably contains 30 to 100 percent by weight of the monomer (a) and 0 to 70 percent by weight of the monomer (b) and more preferably contains 50 to 100 percent by weight of the monomer (a) and 0 to 50 percent by weight of the monomer (b). If the content of the monomer (a) is less than 30 percent by weight, the cured product may have a significantly decreased glass transition temperature Tg.

Various azo compounds having no nitrile group can be used as polymerization initiators for the (co)polymerization of the monomers (a) and (b). Among them, preferred examples include 2,2′-azobis(2,4,4-trimethylpentane) and dimethyl 2,2′-azobisisobutyrate. The amount of such an azo compound having no nitrile group may be 2 to 15 parts by weight and is preferably 3 to 10 parts by weight, to 100 parts by weight of the total amount of the monomers (a) and (b). If the amount of the azo compound having no nitrile group is less than 2 parts by weight, the polymerization may proceed slowly. In contrast, if it exceeds 15 parts by weight, side reactions may occur and/or the resulting (co)polymer may have an unsatisfactorily increased weight-average molecular weight and a broad molecular weight distribution.

The radical (co)polymerization may be carried out under regular conditions. For example, it may be carried out at temperatures of 60° C. to 120° C., preferably 70° C. to 100° C. and is preferably carried out in an inert gas atmosphere. The radical (co)polymerization may be carried out in an organic solvent for stable polymerization. Organic solvents usable herein include hydrocarbon solvents such as toluene and xylenes; ester solvents such as n-butyl acetate, methyl Cellosolve acetate, and propylene glycol monomethyl ether acetate; ketone solvents such as methyl isobutyl ketone and diisobutyl ketone; and ether solvents such as ethylene glycol monomethyl ether and ethylene glycol monoethyl ether. Among them, propylene glycol monomethyl ether acetate and ethylene glycol monoethyl ether are preferred from the viewpoints of the PRTR (Pollutant Release and Transfer Register) Law and the toxicities.

The amount of the organic solvent may be 40 to 900 parts by weight and is preferably 60 to 400 parts by weight, to 100 parts by weight of the total amount of the monomers (a) and (b). If the amount of the organic solvent is less than 40 parts by weight, effects of the use of the organic solvent may not be obtained. If it exceeds 900 parts by weight, the resulting radical (co)polymer may not have a sufficiently increased molecular weight and may contain increased amounts of residual monomers (a) and (b). The radical (co)polymer may have a weight-average molecular weight of 1,000 to 100,000 and preferably 3,000 to 50,000. If the weight-average molecular weight of the radical (co)polymer is less than 1,000, a cured product obtained as a result of thermal setting of the composition may have poor anti-cracking properties. In contrast, if it exceeds 100,000, the resulting thermally cured product may have a decreased glass transition temperature Tg and deteriorated anti-cracking properties, because unreacted portions may reside in a crosslinking reaction with at least one selected from polybasic acid anhydrides and polybasic acids.

Polybasic acid anhydrides and/or polybasic acids (B) for use in the present invention include, for example, hexahydrophthalic acid, methyltetrahydrophthalic acid, methylhexahydrophthalic acid, tetrahydrophthalic acid, methylnadic acid, hydrogenated methylnadic acid, succinic acid, adipic acid, maleic acid, sebacic acid, dodecanedioic acid, and their anhydrides. Among them, methylhexahydrophthalic anhydride and hexahydrophthalic anhydride are preferred for higher optical transparency and light stability of the cured product.

The amount of polybasic acid anhydride or polybasic acid (B) may be 0.7 to 1.3 equivalents, preferably 0.75 to 1.25 equivalents, and more preferably 0.8 to 1.2 equivalents, to 1 equivalent of epoxy group in the radical (co)polymer. If the amount is less than 0.7 equivalent, the thermally cured product may have a decreased glass transition temperature Tg and become poor in anti-cracking properties. If it exceeds 1.3 equivalents, the thermally cured product may also have a decreased glass transition temperature Tg and become in poor anti-cracking properties.

Accelerators (C) for use in the present invention are preferably those other than amines and imidazoles. Specific examples thereof include phosphines such as triphenylphosphine and tris(dimethoxy)phosphine; metal chelates such as aluminum acetylacetone complex; phosphonium salts such as tetramethylphosphonium bromide and tetra-n-butylphosphonium bromide; quaternary ammonium salts such as tetraethylammonium bromide, tetrabutylammonium bromide; metal salts of aliphatic acids, such as tin octylate, zinc octylate, and zinc stearate; organic acid salts of diazabicycloalkenes, such as octylic acid salt of 1,8-diazabicyclo[5.4.0]undecene-7; and boron compounds such as boron trifluoride and tetraphenylphosphonium tetraphenylborate. Of these, triphenylphosphine, tetramethylphosphonium bromide, and tetrabutylammonium bromide are preferred for higher optical transparency and further light stability of the cured product. If amines and imidazoles are used as accelerators, the resulting cured product may have remarkably decreased light stability.

Each of these accelerators (C) can be used alone or in combination.

The amount of the accelerator (C) is preferably 0.1 to 5 parts by weight to 100 parts by weight of the radical (co)polymer (A). If the amount is less than 0.1 parts by weight, curing may proceed at a lower rate and fail to provide sufficient crosslinking. If it exceeds 5 parts by weight, the cured product may have deteriorated optical transparency and become relatively unstable against light.

Thermosetting resin compositions according to the present invention may further include an active hydrogen source such as ethylene glycol, propylene glycol, or ethylene glycol monoethyl ether, in addition to the essential components. The amount of the active hydrogen source is preferably 0.5 to 5 parts by weight to 100 parts by weight of the radical (co)polymer (A). If the amount is less than 0.5 part by weight, the resin composition may foam upon curing with the polybasic acid or an anhydride thereof. If it exceeds 5 parts by weight, the cured product may become relatively unstable against light.

Thermosetting resin compositions according to the present invention may further contain one or more antioxidants. Representative examples of antioxidants include hindered phenolic antioxidants such as pentaerythrityl-tetrakis[3-(3,5-di-t-butyl-4-hydroxyphenyl)propionate] and octadecyl-3-(3,5-di-t-butyl-4-hydroxyphenyl)propionate; and phosphorus stabilizers such as tris(2,4-di-t-butylphenyl)phosphite. The thermosetting resin compositions may contain two or more different hindered phenolic antioxidants; two or more different phosphorus stabilizers; or one or more hindered phenolic antioxidants in combination with one or more phosphorus stabilizers.

Thermosetting resin compositions according to the present invention may further contain other components within ranges not adversely affecting the advantages of the present invention. Such other components include, for example, other epoxy resins, reinforcing agents, fillers, colorants, flame-retarders, coupling agents, ultraviolet absorbers, flexibility-imparting agents, plasticizers, mold releasing agents, and antistatic agents.

Examples of epoxy resins usable herein are aromatic epoxy resins such as bisphenol-A epoxy resins, bisphenol-F epoxy resins, phenol novolac epoxy resins, cresol novolac epoxy resins, hydrogenated bisphenol-A epoxy resins, bisphenol-S epoxy resins, bisphenol-AD epoxy resins, biphenyl epoxy resins, naphthalene epoxy resins, and fluorene epoxy resins; cycloaliphatic epoxy resins such as (3,4-epoxycyclohexyl)methyl 3′,4′-epoxycyclohexanecarboxylate, caprolactone-modified (3,4-epoxycyclohexyl)methyl 3′,4′-epoxycyclohexanecarboxylate, 1,2-epoxy-4-(2-oxiranyl)cyclohexane adduct of 2,2-bis(hydroxymethyl)-1-butanol, and limonene diepoxide; glycidyl ethers of aliphatic alcohols, such as cyclohexanedimethanol diglycidyl ether; and glycidyl ethers of saturated polybasic acids, such as hexahydrophthalic anhydride diglycidyl ester. Each of these epoxy resins can be used alone or in combination.

The above-mentioned components may be sufficiently blended using a generally used apparatus such as a mixer including a blender. The mixture may be melted and kneaded using a hot roll or kneader, cooled, and pulverized to yield a molding compound. If an epoxy resin to be used is liquid, the components may be sufficiently blended in a mixing tank equipped with stirring blades with heating to thereby yield a molding compound. When a cured product is prepared by molding using a sealant for optical devices, the cured product may be molded by a molding process such as transfer molding, compression molding, injection molding, casting, potting, or dipping.

Curing of thermosetting resin compositions according to the present invention may be carried out at temperatures of 50° C. to 250° C., preferably 80° C. to 230° C., and more preferably 100° C. to 200° C. for 30 to 600 minutes, preferably 45 to 480 minutes, and more preferably 60 to 360 minutes.

The resin compositions may not be sufficiently cured if the curing temperature and/or curing time is lower than the lower limit of the above range. In contrast, resin components may decompose if these parameters exceed the upper limit of the above range. While depending on various conditions, the curing conditions can be appropriately adjusted. For example, the curing time may be set short when the curing temperature is high. In contrast, the curing time may be set long when the curing temperature is low. In general, insufficient curing is preferably avoided by sequentially carrying out primary curing and secondary curing. The primary curing may be carried out at temperatures of 80° C. to 220° C., preferably 100° C. to 200° C., and more preferably 120° C. to 180° C. for 0.1 to 60 minutes, preferably 0.1 to 30 minutes, and more preferably 0.1 to 20 minutes. The secondary curing may be carried out at temperatures of 50° C. to 250° C., preferably 80° C. to 230° C., and more preferably 100° C. to 200° C., for 30 to 600 minutes, preferably 45 to 480 minutes, and more preferably 60 to 360 minutes. Thus, cured products according to the present invention may be obtained. The resulting cured products are highly optically transparent, have high glass transition temperatures Tg, are satisfactorily stable against light, and are excellent in anti-cracking properties.

Thermosetting resin compositions according to the present invention may be applied not only to sealants for optical devices but also to other uses in which resulting articles desirably have optical transparency. Examples thereof are protecting films, adhesives, and coating agents to be applied to substrate materials such as polarizers and color filters in liquid crystal displays.

### EXAMPLES

The present invention will be illustrated in further detail with reference to several examples below, which by no means limit the scope of the present invention.

The properties of cured products were determined by the following methods.

Optical transparency: A test piece 3 mm thick was prepared using a mold having a mirror-finished inner surface. The light transmittance at a wavelength of 400 nm of the test piece was determined according to Japanese Industrial Standards (JIS) K-7105 before ultraviolet ray irradiation. A higher light transmittance means higher optical transparency.

Light stability: Ultraviolet rays at 300 to 400 nm were applied to a sample (cured product) at an irradiation energy of 180 W/m², a black panel temperature of 63° C., and humidity of 50% for 100 hours using Super Xenon Weather Meter. The light transmittance at a wavelength of 400 nm of the sample after irradiation was determined. A less change in light transmittance between before and after the irradiation means more excellent light stability.

Glass transition temperature Tg: The glass transition temperature Tg was measured at a rate of temperature rise of 5° C. per minute using a thermomechanical analyzer (TMA) available from Seiko Instruments Inc.

Anti-cracking property: The anti-cracking property was determined by an Izod impact test according to JIS K-7110.

### Preparation Example 1

In a flask equipped with a stirrer, a reflux condenser, a dropping funnel, and a thermometer was placed 150 g of propylene glycol monomethyl ether acetate. A solution mixture was added dropwise over about three hours while blowing nitrogen into a vapor phase and controlling the temperature in the reaction system at 80° C. The solution mixture contained 150 g of propylene glycol monomethyl ether acetate, 300 g of (3,4-epoxycyclohexyl)methyl methacrylate [a product of Daicel Chemical Industries, Ltd. under the trade name of “CYCLOMER M100”], and 24 g of dimethyl 2,2′-azobisisobutyrate. After the completion of the dropwise addition, the reaction mixture was aged for fourteen hours, and the reaction was completed. Next, low-boiling compounds were removed under reduced pressure to thereby yield 290 g of a radical polymer. The radical polymer had a weight-average molecular weight of 21000 and an epoxy equivalent of 204.

### Preparation Example 2

A radical polymer (290 g) was prepared by the procedure of Preparation Example 1, except for using 240 g of “CYCLOMER M100” and 60 g of n-butyl acrylate instead of 300 g of “CYCLOMER M100”. The radical polymer had a weight-average molecular weight of 23000 and an epoxy equivalent of 257.

### Preparation Example 3

A radical polymer (290 g) was prepared by the procedure of Preparation Example 1, except for using 24 g of 2,2′-azobis(2-methylbutyronitrile) instead of 24 g of dimethyl 2,2′-azobisisobutyrate and for carrying out aging for eleven hours after the completion of the dropwise addition of the solution mixture. The radical polymer had a weight-average molecular weight of 18000 and an epoxy equivalent of 204.

### Example 1

A thermosetting resin composition was prepared by heating and mixing a material mixture in a flask equipped with a stirrer, a reflux condenser and a thermometer at 100° C. for sixty minutes, cooling the molten mixture, and pulverizing the cooled mixture. The material mixture contained 100 parts by weight of the radical polymer prepared according to Preparation Example 1, 70 parts by weight of hexahydrophthalic anhydride [a product of New Japan Chemical Co., Ltd. under the trade name of “Rikacid HH”], 0.5 part by weight of tetrabutylammonium bromide as an accelerator, and 1 part by weight of ethylene glycol as an active hydrogen source. The resulting composition was molded into a test piece 3 mm thick using a transfer molding machine at a mold temperature of 175° C. and an injection pressure of 75 kg/cm² for a curing time of two minutes. The test piece was then subjected to postcure at 180° C. for two hours and thereby yielded an optically transparent cured product.

### Example 2

An optically transparent cured product was prepared by the procedure of Example 1, except for using 100 parts by weight of the radical polymer prepared according to Preparation Example 2 as a radical polymer and for using “Rikacid HH” in an amount of 55 parts by weight.

### Example 3

An optically transparent cured product was prepared by the procedure of Example 1, except for further using 1 part by weight of IRGANOX B225 (a product of Ciba Specialty Chemicals Corporation) as an antioxidant.

### Comparative Example 1

A thermosetting resin composition was prepared by the procedure of Example 1, except for using 100 parts by weight of a bisphenol-A epoxy resin [a product of Tohto Kasei Co., Ltd. under the trade name of “YD-128”] instead of the radical polymer prepared according to Preparation Example 1, for using “Rikacid HH” in an amount of 76 parts by weight, and for carrying out heating and mixing the mixture at 60° C. for sixty minutes. The resulting composition was immediately defoamed, placed into a mold, heated in an oven at 120° C. for one hour, further heated at 180° C. for two hours, and thereby yielded an optically transparent cured product.

### Comparative Example 2

A thermosetting resin composition was prepared by the procedure of Example 1, except for using 100 parts by weight of (3,4-epoxycyclohexyl)methyl 3′,4′-epoxycyclohexanecarboxylate [a product of Daicel Chemical Industries, Ltd. under the trade name of “CEL-2021P”] instead of the radical polymer prepared according to Preparation Example 1, for using “Rikacid HH” in an amount of 105 parts by weight, and for carrying out heating and mixing the mixture at 60° C. for sixty minutes. The resulting composition was immediately defoamed, placed into a mold, heated in an oven at 120° C. for one hour, further heated at 180° C. for two hours, and thereby yielded an optically transparent cured product.

### Comparative Example 3

An optically transparent cured product was prepared by the procedure of Example 1, except for using 100-parts by weight of the radical polymer prepared according to Preparation Example 3 as a radical polymer. Table 1 shows the properties of the cured products.

TABLE 1

| | | Ex. 1 | Ex. 2 | Ex. 3 | Com. Ex. 1 | Com. Ex. 2 | Com. Ex. 3 |
|---|---|---|---|---|---|---|---|
| Component (A) | (part by | Radical | Radical | Radical | YD-128 | CEL-2021P | Radical |
| | weight) | polymer of | polymer of | polymer of | 100 | 100 | polymer of |
| | | Prep. Ex. 1 | Prep. Ex. 2 | Prep. Ex. 1 | | | Prep. Ex. 3 |
| | | 100 | 100 | 100 | | | 100 |
| Component (B) | (part by | Rikacid HH | Rikacid HH | Rikacid HH | Rikacid HH | Rikacid HH | Rikacid HH |
| | weight) | 70 | 55 | 70 | 76 | 105 | 70 |
| Component (C) | (part by | TBABr²⁾ | TBABr²⁾ | TBABr²⁾ | TBABr²⁾ | TBABr²⁾ | TBABr²⁾ |
| | weight) | 0.5 | 0.5 | 0.5 | 0.5 | 0.5 | 0.5 |
| Antioxidant | (part by | — | — | IRGANOX B225 | — | — | — |
| | weight) | | | 1 | | | |
| EG¹⁾ | (part by | 1 | 1 | 1 | 1 | 1 | 1 |
| | weight) | | | | | | |
| Curing condition | | 180° C. for 2 hrs | | | 120° C. for 1 hr and | | 180° C. |
| | | | | | 180° C. for 2 hrs | | for 2 hrs |
| Light | (%) | 86 | 87 | 87 | 87 | 87 | 86 |
| transmittance | | | | | | | |
| before UV | | | | | | | |
| irradiation | | | | | | | |
| Light | (%) | 83 | 83 | 84 | 75 | 84 | 80 |
| transmittance | | | | | | | |
| after UV | | | | | | | |
| irradiation | | | | | | | |
| Tg of cured | (° C.) | 184 | 156 | 182 | 128 | 189 | 182 |
| product | | | | | | | |
| Izod impact | (kgf/mm²) | 1.5 | 1.8 | 1.5 | 1.3 | 1.2 | 1.5 |

Component (A): Radical (co)polymer or epoxy resin
Component (B): Polybasic acid anhydride
Component (C): Accelerator
¹⁾EG: Ethylene glycol
²⁾TBABr: Tetrabutylammonium bromide

These results demonstrate that thermosetting resin compositions according to the present invention yield cured products which are highly optically transparent, have high glass transition temperatures Tg, are satisfactorily stable against light, and are excellent in anti-cracking properties. The thermosetting resin compositions contain, as essential components, a radical (co)polymer (A), at least one component (B) selected from polybasic acid anhydrides and polybasic acids, and an accelerator (C), in which the radical (co)polymer (A) is a product of (co)polymerization of an ethylenically unsaturated monomer (a), optionally with an ethylenically unsaturated monomer (b), using a non-nitrile azo compound as a polymerization initiator. The ethylenically unsaturated monomer (a) has one or more cycloaliphatic epoxy groups per molecule, and the ethylenically unsaturated monomer (b) is copolymerizable with the monomer (a).

### INDUSTRIAL APPLICABILITY

According to the present invention, there are provided thermosetting resin compositions that yield cured products having high optical transparency, high glass transition temperatures Tg, showing satisfactory light stability and being excellent in anti-cracking properties. The thermosetting resin compositions according to the present invention are advantageously used typically as sealants for optical devices.

1. A thermosetting resin composition comprising a radical (co)polymer (A); at least one component (B) selected from polybasic acid anhydrides and polybasic acids; and an accelerator (C) as essential components, wherein the radical (co)polymer (A) is a product of (co)polymerization of an ethylenically unsaturated monomer (a), optionally with an ethylenically unsaturated monomer (b), using a non-nitrile azo compound as a polymerization initiator, the ethylenically unsaturated monomer (a) having one or more cycloaliphatic epoxy groups per molecule, and the ethylenically unsaturated monomer (b) being copolymerizable with the monomer (a).

2. The thermosetting resin composition according to claim 1, wherein the ethylenically unsaturated monomers (a) and (b) are free from carboxyl group and hydroxyl group.

3. The thermosetting resin composition according to claim 1, wherein the accelerator (C) is an accelerator other than amines and imidazoles.

4. A sealant for optical devices mainly comprising the thermosetting resin composition according to claim 1.

5. A cured product obtained by curing the thermosetting resin composition according to claim 1.
